(19) United States
(12) Patent Application Publication
(10) Pub. No.: US 2024/0220308 A1
(43) Pub. Date: Jul. 4, 2024

(54) IN-VEHICLE APPARATUS, INFORMATION PROCESSING METHOD, AND COMPUTER PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Masahiro ENDO, Yokkaichi-shi, Mie (JP)

(21) Appl. No.: 18/550,159

(22) PCT Filed: Feb. 28, 2022
(86) PCT No.: PCT/JP2022/008263

§ 371 Date: Sep. 12, 2023

(30) Foreign Application Priority Data
Mar. 18, 2021 (JP) 2021-045022

(51) Int. Cl. G06F 9/455; B60R 16/023

(52) U.S. Cl. CPC G06F 9/45558; B60R 16/0231; G06F 2009/45562

(57) ABSTRACT

An in-vehicle apparatus is an in-vehicle apparatus that is mounted in a vehicle and generates a plurality of virtual devices that are operating environments for a plurality of programs. The in-vehicle apparatus includes a management unit that manages the plurality of virtual devices. The management unit specifies a vehicle state that indicates the state of the vehicle and, based on the specified vehicle state, determines a piece of allocation information for allocating the virtual devices to the own apparatus, and applies the determined allocation information to the virtual devices.

### CROSS-REFERENCE TO RELATED APPLICATIONS

This application is the U.S. national stage of PCT/JP2022/008263 filed on Feb. 28, 2022, which claims priority of Japanese Patent Application No. JP 2021-045022 filed on Mar. 18, 2021, the contents of which are incorporated herein.

### TECHNICAL FIELD

The present disclosure relates to an in-vehicle apparatus, an information processing method, and a computer program.

### BACKGROUND

There are known in-vehicle apparatus that are mounted in vehicles to control devices mounted in the vehicles (for example, JP 2017-87773A). The in-vehicle apparatus in JP 2017-87773A includes a central processing unit (CPU), for example, a single core CPU having one core or a multi-core CPU having a plurality of cores. A plurality of program systems operate on the CPU. The above-described in-vehicle apparatus is equipped with a hypervisor as a constituent element of a function implemented by executing a program. The in-vehicle apparatus uses the hypervisor to generate and operate a plurality of virtual devices in parallel on the vehicle CPU and operate an operating system (OS) on the generated virtual devices.

In the in-vehicle apparatus in Patent Document 1, the plurality of generated virtual devices are allocated according to rules regarding a predetermined time and order or the like. However, the processing loads applied to the virtual devices may differ depending on the state of the vehicle. Thus, the state of the vehicle is desirably taken into consideration in the allocation of the virtual devices.

The present disclosure has been made in view of such circumstances, and an object of the present disclosure is to provide an in-vehicle apparatus and the like that can appropriately allocate virtual devices in accordance with the state of the vehicle.

### SUMMARY

An in-vehicle apparatus according to an aspect of the present disclosure is an in-vehicle apparatus that is mounted in a vehicle and generates a plurality of virtual devices that are operating environments for a plurality of programs, and includes a management unit that manages the plurality of virtual devices. The management unit specifies a vehicle state that indicates the state of the vehicle and, based on the specified vehicle state, determines a piece of allocation information for allocating the virtual devices to the own apparatus, and applies the determined allocation information to the virtual devices.

### Advantageous Effects

According to an aspect of the present disclosure, it is possible to appropriately allocate virtual devices in accordance with the state of the vehicle.

### BRIEF DESCRIPTION OF DRAWINGS

FIG. 1 is a schematic diagram illustrating a configuration of an in-vehicle system according to a first embodiment.

FIG. 2 is a block diagram illustrating a physical configuration of an in-vehicle ECU.

FIG. 3 is a block diagram illustrating a logical configuration of the in-vehicle ECU.

FIG. 4 is a conceptual diagram illustrating contents of an allocation information table.

FIG. 5 is an illustrative diagram showing an example of specification of a vehicle state and switching of allocation information.

FIG. 6 is an illustrative diagram showing virtual ECUs that are allocated to a first computation device, a second computation device, and a third computation device when allocation information is switched from No. 1 allocation information to No. 2 allocation information.

FIG. 7 is an illustrative diagram showing virtual ECUs that are allocated to the first computation device when allocation information has been switched from No. 3 allocation information to No. N+1 allocation information.

FIG. 8 is a flowchart of a process relating to allocation of virtual ECUs performed by a management unit.

FIG. 9 is an illustrative diagram showing an example of specification of a vehicle state and switching of allocation information in a second embodiment.

FIG. 10 is a flowchart of a process relating to allocation of virtual ECUs performed by a management unit in the second embodiment.

### DETAILED DESCRIPTION OF PREFERRED EMBODIMENTS

First, embodiments of the present disclosure will be listed and described. At least some of the embodiments described below may be combined in a desired manner.

An in-vehicle apparatus according to an aspect of the present disclosure is an in-vehicle apparatus that is mounted in a vehicle and generates a plurality of virtual devices that are operating environments for a plurality of programs. The in-vehicle apparatus includes a management unit that manages the plurality of virtual devices. The management unit specifies a vehicle state that indicates the state of the vehicle and, based on the specified vehicle state, determines a piece of allocation information for allocating the virtual devices to the own apparatus, and applies the determined allocation information to the virtual devices.

In this aspect, the in-vehicle apparatus includes a control unit that executes the plurality of programs. The control unit activates a virtualization operating system to generate the plurality of virtual devices. The programs are executed on the virtual devices. The control unit also functions as the management unit that manages the plurality of virtual devices. The in-vehicle apparatus stores the pieces of allocation information for the management unit to allocate the virtual devices to the in-vehicle apparatus. The management unit specifies the vehicle state, and based on the specified vehicle state, determines a piece of allocation information. The management unit applies the determined allocation information to the virtual devices. In other words, the management unit uses the determined allocation information to allocate the virtual devices to the in-vehicle apparatus. When the management unit applies the determined allocation information, if current allocation information that is the allocation information applied at the current time and next allocation information that is the determined allocation information are identical, the determined allocation information to be applied to the virtual devices remains the current allocation information. If the current allocation information that is allocation information applied at the current time and the next allocation information that is the determined allocation information are different, the management unit applies the next allocation information to switch the allocation information to be used for allocating the virtual devices from the current allocation information to the next allocation information. The management unit can appropriately change the allocation of the virtual devices to the in-vehicle apparatus in accordance with the vehicle state. In other words, the management unit can appropriately allocate the virtual devices to the in-vehicle apparatus in accordance with the vehicle state.

n the in-vehicle apparatus according to an aspect of the present disclosure, the management unit acquires specification information for specifying the vehicle state from the virtual devices, and specifies the vehicle state based on the acquired specification information.

In this aspect, the management unit acquires the specification information for specifying the vehicle state from the virtual devices. The specification information includes the results of detection by an in-vehicle device such as a sensor mounted in the vehicle, for example. The management unit specifies the vehicle state based on the acquired specification information. The management unit determines the allocation information based on the specified vehicle state. Since the virtual devices do not need to specify the vehicle state, it is possible to reduce the processing performed by the virtual devices.

In an in-vehicle apparatus according to an aspect of the present disclosure, the virtual devices specify the vehicle state, and the management unit acquires the vehicle state specified by the virtual devices from the virtual devices.

In this aspect, the virtual devices specify the vehicle state, and output the specified vehicle state to the management unit. The management unit acquires the vehicle state output from the virtual devices, and determines the allocation information based on the acquired vehicle state. Since the management unit acquires the vehicle state specified by the virtual devices from the virtual devices, it is possible to reduce the processing performed by the management unit to specify the vehicle state.

In an in-vehicle apparatus according to an aspect of the present disclosure, the management unit specifies the vehicle state based on the state of hardware of the own apparatus.

In this aspect, the management unit specifies the vehicle state based on the state of hardware of the in-vehicle apparatus. The state of the hardware includes a load on the hardware, for example, the frequency with which the in-vehicle apparatus communicates. The management unit determines the allocation information based on the specified vehicle state. Since the virtual devices do not need to perform any processing in the specification of the vehicle state, it is possible to reduce the processing performed by the virtual devices.

In an in-vehicle apparatus according to an aspect of the present disclosure, the management unit specifies the vehicle state a plurality of times. If, among the plurality of specified vehicle states, an identical vehicle state has continued a predetermined number of times or more, the management unit determines the allocation information based on the identical vehicle state.

In this aspect, the management unit specifies the vehicle state a plurality of times. The management unit determines whether or not, among the plurality of specified vehicle states, an identical vehicle state has continued the predetermined number of times. If an identical vehicle state has continued the predetermined number of times or more, the management unit determines the allocation information based on the identical vehicle state, and applies the determined allocation information to the virtual devices. In other words, the management unit uses the allocation information determined based on the identical vehicle state having continued the predetermined number of times or more to allocate the virtual devices. If no identical vehicle state has continued the predetermined number of times or more, the management unit does not determine the allocation information. The management unit uses the allocation information already applied to the virtual devices to allocate the virtual devices. Even if the frequency of change in the vehicle state is high, the management unit can appropriately allocate the virtual devices to the in-vehicle apparatus.

In an in-vehicle apparatus according to an aspect of the present disclosure, the management unit specifies the vehicle state a plurality of times. If, among the plurality of specified vehicle states, the number of times an identical vehicle state has been specified is greater than or equal to a predetermined value, the management unit determines the allocation information based on the identical vehicle state.

In this aspect, the management unit specifies the vehicle state a plurality of times. The management unit determines whether or not, among the plurality of specified vehicle states, the number of times an identical vehicle state has been specified is greater than or equal to a predetermined value. The predetermined value is a value of 50% or more of the plurality of times, for example. If the number of times an identical vehicle state has been specified is greater than or equal to the predetermined value, the management unit determines the allocation information based on the identical vehicle state that has been specified a number of times greater than or equal to the predetermined value, and applies the determined allocation information to the virtual devices. In other words, the management unit uses the allocation information determined based on the identical vehicle state that has been specified a number of times greater than or equal to the predetermined value to allocate the virtual devices. If the number of times the identical vehicle state has been specified is smaller than the predetermined value, the management unit does not determine the allocation information. The management unit uses the allocation information already applied to the virtual devices to allocate the virtual devices. Even if the frequency of change in the vehicle state is high, the management unit can appropriately allocate the virtual devices to the in-vehicle apparatus.

In an in-vehicle apparatus according to an aspect of the present disclosure, the management unit applies the allocation information to change the type of the virtual devices to be allocated.

In this aspect, the type of virtual devices to be allocated to the in-vehicle apparatus is changed as a result of the management unit applying the allocation information. The management unit can allocate the appropriate kind of the virtual devices suited for the vehicle state to the in-vehicle apparatus.

In an in-vehicle apparatus according to an aspect of the present disclosure, the management unit applies the allocation information to change the number of virtual devices to be allocated.

In this aspect, the number of virtual devices to be allocated to the in-vehicle apparatus is changed as a result of the management unit applying the allocation information. The management unit can allocate an appropriate number of virtual devices suited for the vehicle state to the in-vehicle apparatus.

In an in-vehicle apparatus according to an aspect of the present disclosure, the management unit applies the allocation information to change at least one of times at which the virtual devices are to be allocated.

In this aspect, at least one of the times at which the virtual devices are to be allocated to the in-vehicle apparatus is changed as a result of the management unit applying the allocation information. The management unit can allocate the virtual devices at the appropriate times suited for the vehicle state to the in-vehicle apparatus.

In an in-vehicle apparatus according to an aspect of the present disclosure, the management unit applies the allocation information to change a cycle time in which the virtual devices are to be allocated.

In this aspect, the cycle time in which the virtual devices are to be allocated to the in-vehicle apparatus is changed as a result of the management unit applying the allocation information. The management unit can allocate the virtual devices to the in-vehicle apparatus in the appropriate cycle time suited for the vehicle state.

An information processing method according to an aspect of the present disclosure is an information processing method performed by an in-vehicle apparatus that is mounted in a vehicle and generates a plurality of virtual devices that are operating environments of a plurality of programs. The information processing method includes: specifying a vehicle state that indicates the state of the vehicle; based on the specified vehicle state, determining a piece of allocation information for allocating the virtual devices to the in-vehicle apparatus; and applying the determined allocation information to the virtual devices.

In this aspect, as in aspect (1), it is possible to appropriately allocate the virtual devices to the in-vehicle apparatus in accordance with the vehicle state.

A computer program according to an aspect of the present disclosure is a computer program for causing a computer that is mounted in a vehicle and generates a plurality of virtual devices that are operating environments of a plurality of programs, to execute a process. The process includes: specifying a vehicle state that indicates the state of the vehicle; based on the specified vehicle state, determining a piece of allocation information for allocating the virtual devices to the computer; and applying the determined allocation information to the virtual devices.

In this aspect, it is possible to cause the computer to function as an in-vehicle apparatus in an aspect of the present disclosure.

The present disclosure will be described in detail with reference to the drawings showing embodiments of the present disclosure. An in-vehicle apparatus according to the embodiments of the present disclosure will be described below with reference to the drawings. It should be noted that the present disclosure is not limited to the examples herein, but rather is indicated by the scope of claims, and is intended to include all modifications within a meaning and scope equivalent to the scope of claims.

### First Embodiment

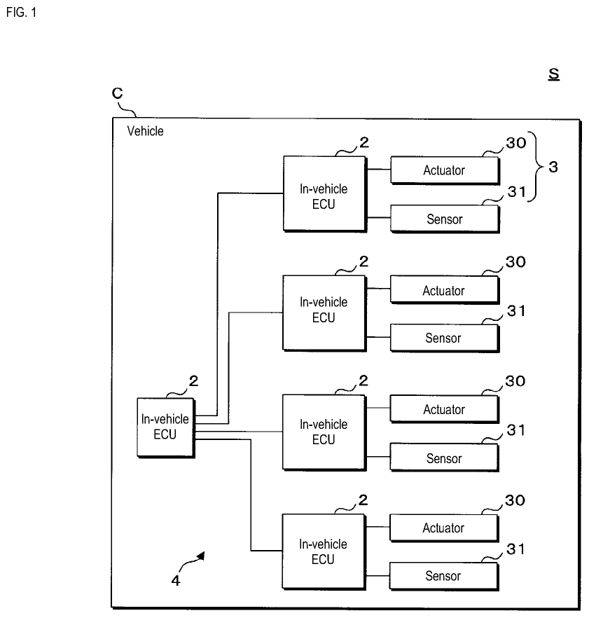

Hereinafter, embodiments will be described with reference to the drawings. FIG. 1 is a schematic diagram illustrating a configuration of an in-vehicle system S according to a first embodiment. The in-vehicle system S includes a plurality of in-vehicle ECUs 2 mounted in a vehicle C. In-vehicle devices 3 are connected to the in-vehicle ECUs 2.

The plurality of in-vehicle ECUs 2 may include a comprehensive in-vehicle ECU 2 (comprehensive ECU) that controls the entire vehicle C and individual in-vehicle ECUs 2 (individual ECUs) that are communicably connected to the comprehensive ECU 2 and are connected directly to the in-vehicle devices 3. The comprehensive in-vehicle ECU 2 may be communicably connected to an external server (not shown) that is connected to an external network such as the Internet, via an external communication device (not shown). The in-vehicle ECUs 2 correspond to in-vehicle apparatuses.

Referring to FIG. 1, the comprehensive in-vehicle ECU 2 and the individual in-vehicle ECUs 2 are communicably connected via an in-vehicle network 4 that has a star-shaped network topology. The comprehensive in-vehicle ECU 2 is located at the center of the star-shaped network topology. The network topology of the in-vehicle system S is not limited to the foregoing example. The in-vehicle system S may be configured such that individual in-vehicle ECUs 2 adjacent to each other are connected to form a loop-shaped network topology and enable bidirectional communication for redundancy.

The individual in-vehicle ECUs 2 are disposed in areas of the vehicle C and are connected to the in-vehicle devices 3. The individual in-vehicle ECUs 2 transmit and receive signals or data to and from the connected in-vehicle devices 3. The individual in-vehicle ECUs 2 communicate with the comprehensive in-vehicle ECU 2. The individual in-vehicle ECUs 2 may be relay control ECUs that function as in-vehicle relay apparatuses such as gateways or Ethernet (registered trademark) switches that relay communication between the plurality of in-vehicle devices 3 connected to the individual in-vehicle ECUs 2 or communication between the in-vehicle devices 3 and other in-vehicle ECUs 2. In addition to relaying communication, the individual in-vehicle ECUs 2 may also function as power distribution apparatuses that distribute and relay power output from a power storage apparatus (not shown) and supply the power to the in-vehicle devices 3 connected to the own ECUs.

The in-vehicle devices 3 include actuators 30 such as a door open/close device and a motor device, and various sensors 31 such as light detection and ranging (LiDAR) sensors, a light sensor, a CMOS camera, and an infrared sensor, for example. The in-vehicle devices 3 are not limited to the foregoing examples and may be switches such as door switches (SWs) and lamp SWs or lamps.

The comprehensive in-vehicle ECU 2 is a central control apparatus such as a vehicle computer, for example. The comprehensive in-vehicle ECU 2 generates and outputs control signals to the individual in-vehicle devices 3 based on data from the in-vehicle devices 3 that is relayed via another in-vehicle ECU 2 such as an individual in-vehicle ECU 2. Based on information or data such as a request signal output from the other in-vehicle ECU 2, the comprehensive in-vehicle ECU 2 generates a control signal for controlling the actuator 30 that is a target of the request signal and outputs the generated control signal to the other in-vehicle ECU 2. In the present embodiment, the in-vehicle system S is formed by the comprehensive in-vehicle ECU 2 and the individual in-vehicle ECUs 2. However, the in-vehicle system S is not limited to the configuration formed by the comprehensive in-vehicle ECU 2 and the individual in-vehicle ECUs 2. The in-vehicle system S may be formed by a plurality of in-vehicle ECUs 2 that are connected peer-to-peer by controller area network (CAN) gateways or Ethernet switches, for example.

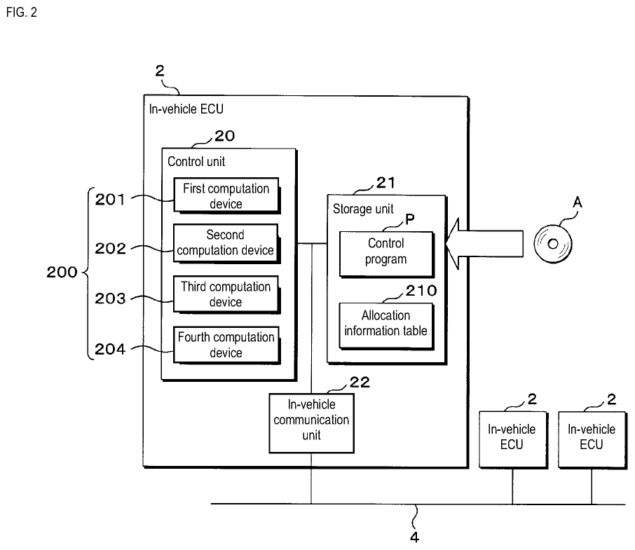

FIG. 2 is a block diagram illustrating a physical configuration of each in-vehicle ECU 2. The in-vehicle ECU 2 includes a control unit 20, a storage unit 21, and an in-vehicle communication unit 22. The control unit 20 is formed by a computation processing device such as a central processing unit (CPU) or a micro processing unit (MPU). The control unit 20 performs various kinds of control processing and computation processing by reading and executing a control program P and data stored in the storage unit 21 in advance. The control unit 20 includes a single CPU with a single core, a multi CPU with a single core, a single CPU with a multi core, and a multi CPU with a multi core, for example. The control unit 20 is not limited to a software processing unit such as a CPU that performs software processing and may include a hardware processing unit such as FPGA, ASIC, or SOC that performs various kinds of control processing and computation processing.

The control unit 20 includes a computation device 200 that is formed by one core of a CPU, for example. In the present embodiment, the control unit 20 is a quad-core CPU as an example. The control unit 20 is a quad-core CPU and thus has four cores. The control unit 20 includes four computation devices 200, that is, a first computation device 201 that is formed by a first core, a second computation device 202 that is formed by a second core, a third computation device 203 that is formed by a third core, and a fourth computation device 204 that is formed by a fourth core. The number of computation devices 200 is not limited to four.

The storage unit 21 is formed by a volatile memory element such as a random access memory (RAM) or a non-volatile memory element such as a read only memory (ROM), an electrically erasable programmable ROM (EEPROM), or a flash memory. The storage unit 21 may be formed by a combination of storage devices such as a volatile memory element and non-volatile memory element. The storage unit 21 stores, in advance, the control program P and data to be referred to during processing. The program P includes a plurality of programs such as programs for controlling the various in-vehicle devices 3 or programs for performing target recognition for automated driving based on output data from a LiDAR or CMOS camera, for example. These programs are also called applications. The storage unit 21 of each in-vehicle ECU 2 stores a virtualization operating system such as Hypervisor, VMware, or Xen. The storage unit 21 also stores a later-described allocation information table 210.

The control program P stored in the storage unit 21 may be a control program P read from a recording medium A that can be read by the in-vehicle ECU 2. The control program P may be a control program P that is downloaded from an external computer (not shown) connected to a communication network (not shown), and is stored in the storage unit 21. The control program P corresponds to a computer program.

The in-vehicle communication unit 22 is an input/output interface that uses a communication protocol of a controller area network (CAN) or Ethernet (registered trademark). The control unit 20 communicates with other in-vehicle ECUs 2 that are connected to the in-vehicle network 4, via the in-vehicle communication unit 22.

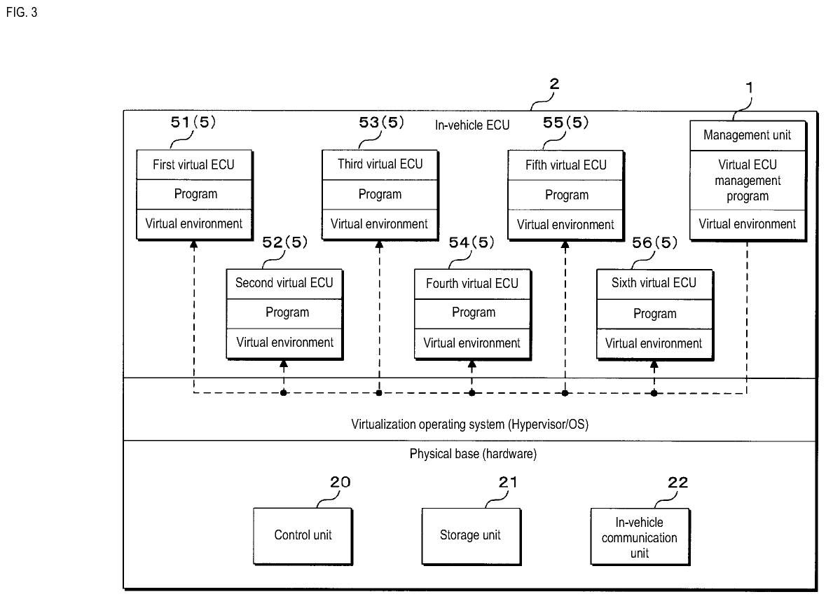

FIG. 3 is a block diagram illustrating a logical configuration of each in-vehicle ECU 2. The block diagram in FIG. 3 illustrates a hierarchical structure in which a hardware layer (physical base) realized by the control unit 20 and the like is the lowermost layer, and a software layer realized by programs executed by the virtual ECUs 5, virtual ECU management programs, and the like is the uppermost layer.

As described above, the storage unit 21 of each in-vehicle ECU 2 stores a virtualization operating system such as Hypervisor, VMware, or Xen, for example. By activating the virtualization operating system, the control unit 20 of the in-vehicle ECU 2 can construct a plurality of virtual ECUs 5 on the virtualization operating system. In the present embodiment, six virtual ECUs 5, that is, a first virtual ECU 51, a second virtual ECU 52, a third virtual ECU 53, a fourth virtual ECU 54, a fifth virtual ECU 55, and a sixth virtual ECU 56, are constructed. The programs for controlling the various in-vehicle devices 3 are executed on any of these virtual ECUs 5 serving as an operating environment. That is, these programs are executed on the virtual ECUs 5. When a virtual ECU 5 executes a program, one or more tasks are generated in accordance with the processed content of the program. The one or more tasks allow execution of processing in more subdivided or segmented units.

In the present embodiment, as an example, the method of virtualization is a hypervisor method by which the virtualization operating system directly accesses hardware resources such as the control unit 20. However, the method of virtualization is not limited to the hypervisor method. For example, the method of virtualization may be a host OS method in which an operating system such as Linux (registered trademark) intervenes between the virtualization operating system and the hardware resources. The method of virtualization may also be a method using a container-type virtualization operating system.

Each in-vehicle ECU 2 activated using the virtualization operating system can construct a plurality of virtual ECUs 5 using the functions of the virtualization operating system. Hardware resources such as the control unit 20 and the storage unit 21 included in the in-vehicle ECU 2 are allocated to the plurality of virtual ECUs 5. For example, each virtual ECU 5 includes a virtual control unit (not shown) that is allocated to the control unit 20, a virtual storage unit (not shown) that is allocated to the storage unit 21, and a virtual in-vehicle communication unit (not shown) that is allocated to the in-vehicle communication unit 22. More specifically, virtual control unit is cyclically allocated to the control unit 20 in a time-divided manner. The virtual storage unit is allocated to the storage unit 21 which is region-divided. The virtual ECU 5 corresponds to a virtual device.

The virtual storage unit in each virtual ECU 5 stores a guest OS such as Ubuntu (registered trademark), for example. Each virtual ECU 5 activates the guest OS and executes programs on the guest OS. The type of guest OS may differ between the individual virtual ECUs 5. As described above, since the entity of the virtual storage unit is a storage area of the storage unit 21 that is allocated to the corresponding virtual ECU 5, it goes without saying that the guest OS is also stored in the storage unit 21 similarly to the virtualization operating system. In the case of using a container-type virtualization operating system, no guest OS is required and containers may be generated on the virtualization operating system and the programs may be executed on the containers. In this case, the containers correspond to the virtual ECUs 5.

In the control unit 20 of each in-vehicle ECU 2 that is activated using the virtualization operating system, a plurality of virtual environments including a plurality of virtual ECUs 5 are constructed. More specifically, a first virtual environment that functions as a plurality of virtual ECUs 5 and a second virtual environment for executing a virtual ECU management program for managing all of the virtual ECUs 5 are constructed. The control unit 20 functions as a control panel of the virtualization operating system by executing the virtual ECU management program in the second virtual environment. In other words, the control unit 20 functions as a management unit 1 that manages the plurality of virtual ECUs 5 by executing the virtual ECU management program in the second virtual environment. The virtual operating system may itself include the functions of the management unit 1. In the present embodiment, the fourth computation device 204 functioning as the management unit 1 by executing the virtual ECU management program is given as an example.

The storage unit 21 stores the allocation information table 210 that contains pieces of allocation information for allocating the virtual ECUs 5 to the in-vehicle ECU 2. The management unit 1 performs allocation of usage times of the computation devices 200 to the individual virtual ECUs 5, that is, performs scheduling, based on the allocation information table 210. For example, the scheduling is performed cyclically. Hereinafter, the usage times of the computation devices 200 allocated to the virtual environments including the virtual ECUs 5 and the management unit 1 will also be called “allocation times of the computation devices 200”. The allocation times of the computation devices 200 correspond to the times for which the virtual devices are allocated.

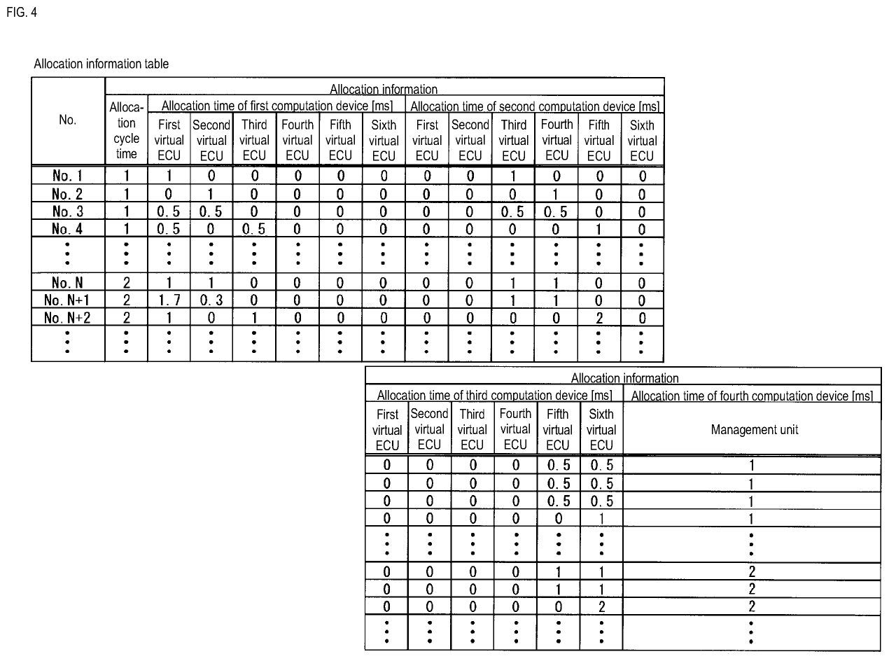

FIG. 4 is a conceptual diagram illustrating the content of the allocation information table 210. The allocation information table 210 contains pieces of allocation information that are associated with numbers (No.). The allocation information constitutes a scheduling table in which information for scheduling is presented in a table format, for example. The allocation information includes the allocation times of the computation devices 200 to the virtual environments constructed in the in-vehicle ECU 2 and allocation cycle times described below.

The allocation information table 210 shown in FIG. 4 includes a number column, an allocation cycle time column, an allocation time column for the first computation device 201, an allocation time column for the second computation device 202, an allocation time column for the third computation device 203, and an allocation time column for the fourth computation device 204. The number column contains numbers for identifying allocation information.

The allocation time column for the first computation device 201 contains the allocation times of the first computation device 201 to the six virtual ECUs 5 constructed in the in-vehicle ECU 2. The allocation time column for the second computation device 202 contains the allocation times of the second computation device 202 to the six virtual ECUs 5. The allocation time column for the third computation device 203 contains the allocation times of the third computation device 203 to the six virtual ECUs 5. The allocation time column for the fourth computation device 204 contains the allocation times of the fourth computation device 204 to the management unit 1.

The allocation cycle time column contains allocation cycle times. The allocation cycle times are cycle times at which the management unit 1 allocates the usage times of the computation devices 200 to the virtual ECUs 5. In other words, the allocation cycle times are time periods during which the management unit 1 allocates the usage times of the computation devices 200 to the virtual ECUs 5. In the allocation information table 210, the numbers, the allocation cycle times, the allocation times of the first computation device 201, the allocation times of the second computation device 202, the allocation times of the third computation device 203, and the allocation times of the fourth computation device 204 are associated with one another. In each piece of allocation information, the total allocation time of the computation devices 200 is equivalent to the allocation cycle time. During the allocation cycle time, the usage times of the computation devices 200 are allocated to one or more virtual ECUs 5. The allocation cycle time is a so-called time slice.

For example, in the case of No. 1 allocation information, in the first computation device 201, the allocation time of the first computation device 201 to the first virtual ECU 51 is 1 ms (msec). The allocation time of the first computation device 201 to the five virtual ECUs 5 excluding the first virtual ECU 51 is 0 ms. That is, the usage time of the first computation device 201 is not allocated to the other five virtual ECUs 5. At this time, the total allocation time of the first computation device 201 is 1 ms.

In the second computation device 202, the allocation time of the second computation device 202 to the third virtual ECU 53 is 1 ms. The allocation time of the second computation device 202 to the five virtual ECUs 5 excluding the third virtual ECU 53 is 0 ms. That is, the usage time of the second computation device 202 is not allocated to the other five virtual ECUs 5. At this time, the total allocation time of the second computation device 202 is 1 ms.

In the third computation device 203, the allocation time of the third computation device 203 to the fifth virtual ECU 55 is 0.5 ms, and the allocation time of the third computation device 203 to the sixth virtual ECU 56 is 0.5 ms. The allocation time of the third computation device 203 to the four virtual ECUs 5 excluding the fifth virtual ECU 55 and the sixth virtual ECU 56 is 0 ms. That is, the usage time of the third computation device 203 is not allocated to the other four virtual ECUs 5. At this time, the total allocation time of the third computation device 203 is 1 ms.

In the fourth computation device 204, the allocation time of the fourth computation device 204 to the management unit 1 is 1 ms. The allocation cycle time is 1 ms, which is identical to the total allocation time of the computation devices 200.

The management unit 1 uses a piece of allocation information stored in the allocation information table 210 to allocate the usage times of the first computation device 201, the second computation device 202, and the third computation device 203 to the virtual ECUs 5. Hereinafter, the allocation of the usage times of the computation devices 200 to the virtual ECUs 5 will also be called “allocation of the virtual ECUs 5”.

Hereinafter, an example of allocation of the virtual ECUs 5 by the management unit 1 will be described. When an ignition (IG) switch (not shown) in the vehicle C has shifted from a stopped state to an activated state, for example, the fourth computation device 204 functions as the management unit 1. The management unit 1 refers to the allocation information table 210 and uses the allocation information preset for use at the time of activation to perform allocation of the virtual ECUs 5. Hereinafter, the allocation information preset for use at the time of activation will also be called “allocation information at the time of activation”. The allocation information at the time of activation is the No. 1 allocation information stored in the allocation information table 210, for example, but is not limited to the No. 1 allocation information. The activation time is the point in time at which the IG switch shifts from the stopped state to the activated state, for example.

If the allocation information at the time of activation is the No. 1 allocation information, the management unit 1 allocates the usage times of three computation devices 200 excluding the fourth computation device 204 to the virtual ECUs 5 during an allocation cycle time of 1 ms. More specifically, the first computation device 201 is allocated to the first virtual ECU 51 for 1 ms. The second computation device 202 is allocated to the third virtual ECU 53 for 1 ms.

The third computation device 203 is allocated to the fifth virtual ECU 55 for 0.5 ms, and after the allocation to the fifth virtual ECU 55, the third computation device 203 is further allocated to the sixth virtual ECU 56 for 0.5 ms. In the foregoing example, the allocation to the fifth virtual ECU 55 takes place earlier than the allocation to the sixth virtual ECU 56. However, the allocation to the sixth virtual ECU 56 may take place earlier than the allocation to the fifth virtual ECU 55. When one computation device 200 is to be allocated to two or more virtual ECUs 5 during one allocation cycle time, the order of allocation to the two or more virtual ECUs 5 is not limited.

The management unit 1 specifies the vehicle state indicating the state of the vehicle C when the allocation cycle time has elapsed from the point in time at which the management unit 1 started allocation of the virtual ECUs 5. In other words, the management unit 1 specifies the vehicle state when the total allocation time of the computation devices 200 described above has elapsed from the point in time at which the management unit 1 started the allocation of the virtual ECUs 5. The specification of the vehicle state will be described later.

For example, the allocation cycle time may include a specification time that is provided after the total allocation time of the computation devices 200 has elapsed from the point in time at which the management unit 1 started the allocation of the virtual ECUs 5, the specification time being for the management unit 1 to perform processing related to the specification of the vehicle state. The specification time is a time for so-called overhead. In this case, the allocation cycle time is a period of time in which the specification time is added to the total allocation time of the computation devices 200. For example, if the total allocation time of the computation devices 200 is 1 ms and the specification time is 0.1 ms, the allocation cycle time is set to 1.1 ms. If the allocation cycle time includes the specification time, the management unit 1 specifies the vehicle state in the specification time after the total allocation time of the computation devices 200 has elapsed from the point in time at which the management unit 1 started the allocation of the virtual ECUs 5. The specification time is not limited to 0.1 ms.

For example, the vehicle state includes a manual driving state in which manual driving is performed, an automatic driving state in which automatic driving is performed, and an IG stopped state in which the IG switch of the vehicle C is in the stopped state. The vehicle state also includes a forward traveling state in which the vehicle C is traveling forward, a backward traveling state in which the vehicle C is traveling backward, and a stopped state in which the vehicle C is stopped. For example, the vehicle state may include a manual driving forward traveling state in which the vehicle C in the manual driving state is traveling forward, a manual driving backward traveling state in which the vehicle C in the manual driving state is traveling backward, and a manual driving stopped state in which the vehicle C in the manual driving state is stopped. The vehicle state may also include an automatic driving forward traveling state in which the vehicle C in the automatic driving state is traveling forward, an automatic driving backward traveling state in which the vehicle C in the automatic driving state is traveling backward, and an automatic driving stopped state in which the vehicle C in the automatic driving state is stopped.

If there is a vehicle state that satisfies a later-described predetermined condition after the allocation cycle time has elapsed, the management unit 1 determines the allocation information to be used in the allocation (scheduling) of the virtual ECUs 5, based on the vehicle state satisfying the predetermined condition. For example, the storage unit 21 stores a switching table in which the vehicle states and the numbers for the allocation information stored in the allocation information table 210 are stored in association with each other. The management unit 1 determines the allocation information by referring to the switching table to acquire the number for the allocation information associated with the vehicle state satisfying the predetermined condition. The allocation information table 210 may contain vehicle states in association with the allocation information. The management unit 1 applies the determined allocation information to the virtual ECUs 5.

When applying the allocation information determined by the management unit 1 to the virtual devices, the allocation information includes current allocation information that is currently being applied to the virtual ECUs 5 and next allocation information that is the allocation information determined by the management unit 1. In the foregoing example, the current allocation information is the No. 1 allocation information. When the management unit 1 applies the determined allocation information to the virtual devices, if the current allocation information and the next allocation information are identical, the allocation information to be applied to the virtual devices remains as the current allocation information. If the current allocation information and the next allocation information are different, the management unit 1 applies the next allocation information to switch the allocation information to be used in the allocation of the virtual devices from the current allocation information to the next allocation information. The management unit 1 uses the applied allocation information to perform allocation of the virtual ECUs 5. Once the allocation cycle time has elapsed as described above, the management unit 1 specifies the vehicle state.

If there is no vehicle state satisfying a predetermined condition, the management unit 1 does not determine the allocation information. The management unit 1 uses allocation information identical to the allocation information used in the immediately previous allocation cycle time to perform the allocation of the virtual ECUs 5. In the foregoing example, the allocation information used by the management unit 1 in the immediately previous allocation cycle time is the No. 1 allocation information. Once the allocation cycle time has elapsed as described above, the management unit 1 specifies the vehicle state.

Hereinafter, specification of the vehicle state will be described. For example, the virtual ECUs 5 acquire specification information for specifying the vehicle state. For example, the specification information includes information regarding the state of an accelerator pedal, a brake pedal, or a shift lever, and the results of detection by the sensors 31 included in the in-vehicle devices 3. The virtual ECUs 5 output the acquired specification information to the management unit 1. The management unit 1 acquires the specification information output from the virtual ECUs 5 and specifies the vehicle state based on the acquired specification information.

For example, the virtual ECUs 5 may specify the vehicle state based on the acquired specification information and output the specified vehicle state to the management unit 1. The management unit 1 acquires the vehicle state output from the virtual ECUs 5. For example, the management unit 1 may specify the vehicle state based on the state of hardware of the in-vehicle ECU 2 in which the management unit 1 and the virtual ECUs 5 are constructed. The state of the hardware includes a load on the hardware and the frequency at which the in-vehicle ECU 2 communicates, for example. If the frequency at which the in-vehicle ECU 2 communicates is high, the load on the hardware is large.

The specification of the vehicle state by the management unit 1 includes the specification of the vehicle state by the management unit 1 based on the specification information or the state of the hardware as described above, and includes the acquisition of the vehicle state specified by the virtual ECUs 5 by the management unit 1 from the virtual ECUs 5. The management unit 1 specifies the vehicle state in each allocation cycle time to specify the vehicle state a plurality of times. In other words, the management unit 1 cyclically specifies the vehicle state. Hereinafter, the cycle time during which the management unit 1 specifies the vehicle state will also be called “specification cycle time”. For example, in the specification of the vehicle state, the management unit 1 acquires the specification information or the vehicle state output from the virtual ECUs 5 in each specification cycle time.

The management unit 1 stores the specified vehicle state in the storage unit 21. For example, the storage unit 21 stores a count value that indicates the number of times the management unit 1 has specified the vehicle state. The management unit 1 increases the count value by 1 each time the vehicle state is specified. When storing the specified vehicle state in the storage unit 21, the management unit 1 stores the specified vehicle state and the increased count value in association with each other. The management unit 1 can determine the order in which the vehicle states stored in the storage unit 21 were specified based on the count value stored in association with the vehicle states.

For example, the management unit 1 may store the specified vehicle state and the time at which the vehicle state was specified in association with each other in the storage unit 21. The management unit 1 can determine the order in which the vehicle states stored in the storage unit 21 were specified based on the times stored in association with the vehicle states.

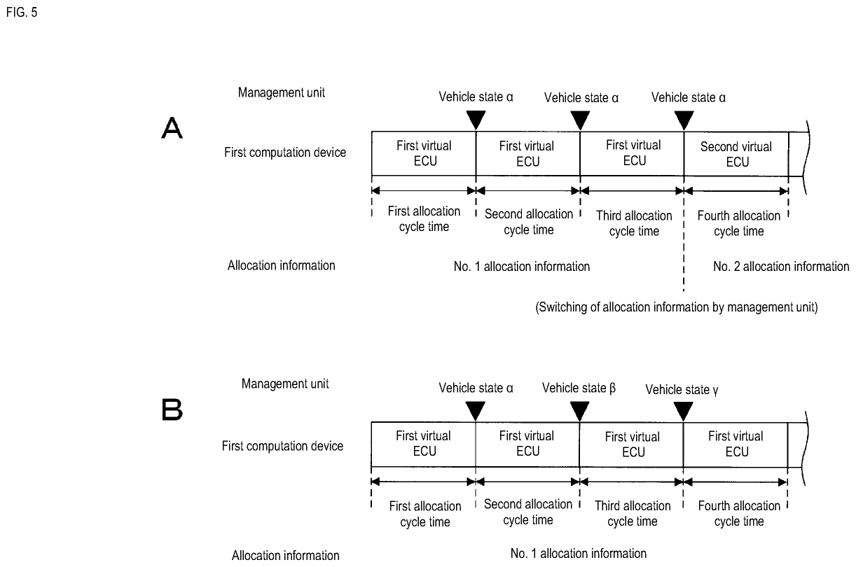

FIG. 5 is an illustrative diagram showing an example of specification of the vehicle state and switching of the allocation information. FIG. 5 shows the management unit 1 and the first computation device 201 for the sake of description. FIG. 5 also shows the points in time at which the management unit 1 specifies the vehicle state with solid black triangles. The management unit 1 specifies the vehicle state once the allocation cycle time has elapsed as described above. That is, the management unit 1 cyclically specifies the vehicle state to specify the vehicle state a plurality of times. Upon specification of the vehicle state, the management unit 1 determines whether an identical vehicle state has been consecutively specified a predetermined number of times or more. In other words, the management unit 1 determines whether, among the plurality of specified vehicle states, an identical vehicle state has continued a predetermined number of times or more. For example, the predetermined number of times is stored in the storage unit 21. Although the predetermined number of times is three in the example in FIG. 5, the predetermined number of times is not limited to three. The predetermined number of times may be two or four or more. The predetermined condition in the present embodiment is that an identical vehicle state has been consecutively specified a predetermined number of times or more.

FIG. 5A is an illustrative diagram showing a case where there is a vehicle state satisfying the predetermined condition, that is, a case where the allocation information is determined. In the example in FIG. 5A, the allocation information to be used in the first allocation cycle time is the No. 1 allocation information. The vehicle state specified by the management unit 1 once the first allocation cycle time has elapsed is a vehicle state a. Since the management unit 1 has not specified an identical vehicle state three consecutive times, the management unit 1 does not determine the allocation information. The management unit 1 uses the No. 1 allocation information again to perform the allocation of the virtual ECUs 5 in the second allocation cycle time. The vehicle state specified by the management unit 1 once the second allocation cycle time has elapsed is the vehicle state a. Since the management unit 1 has not specified an identical vehicle state three consecutive times, the management unit 1 does not determine the allocation information. The management unit 1 uses the No. 1 allocation information again to perform the allocation of the virtual ECUs 5 in the third allocation cycle time.

The vehicle state specified by the management unit 1 once the third allocation cycle time has elapsed is the vehicle state a. Since the management unit 1 has specified the identical vehicle state three consecutive times, the vehicle state a specified by the management unit 1 satisfies the predetermined condition. The management unit 1 determines the allocation information based on the vehicle state α. In other words, if an identical vehicle state has continued a predetermined number of times or more among the plurality of specified vehicle states, the management unit 1 determines the allocation information based on the identical vehicle state. The management unit 1 applies the determined allocation information to the virtual ECUs 5. That is, the management unit 1 uses the determined allocation information to perform the allocation of the virtual ECUs 5. In FIG. 5A, the management unit 1 switches the allocation information from the No. 1 allocation information to the No. 2 allocation information. The management unit 1 uses the No. 2 allocation information to perform the allocation of the virtual ECUs 5 in the fourth allocation cycle time.

FIG. 5B is an illustrative diagram showing a case where there is no vehicle state satisfying the predetermined condition, that is, a case where no allocation information is determined. In the example of FIG. 5B, the allocation information to be used in the first allocation cycle time is the No. 1 allocation information. The vehicle state specified by the management unit 1 once the first allocation cycle time has elapsed is the vehicle state a. Since the management unit 1 has not specified an identical vehicle state three consecutive times, the management unit 1 does not determine the allocation information. The management unit 1 uses the No. 1 allocation information again to perform the allocation of the virtual ECUs 5 in the second allocation cycle time. The vehicle state specified by the management unit 1 once the second allocation cycle time has elapsed is a vehicle state β. Since the management unit 1 has not specified an identical vehicle state three consecutive times, the management unit 1 does not determine the allocation information. The management unit 1 uses the No. 1 allocation information again to perform the allocation of the virtual ECUs 5 in the third allocation cycle time. The vehicle state specified by the management unit 1 once the third allocation cycle time has elapsed is a vehicle state γ. Since the management unit 1 has not specified an identical vehicle state three consecutive times, the management unit 1 does not determine the allocation information. The management unit 1 uses the No. 1 allocation information again to perform the allocation of the virtual ECUs 5 in the fourth allocation cycle time.

The management unit 1 repeats the specification of the vehicle state and the determination as to whether or not there is a vehicle state satisfying the predetermined condition. If there is a vehicle state satisfying the predetermined condition, the management unit 1 determines the allocation information based on the vehicle state satisfying the predetermined condition. In other words, the vehicle state satisfying the predetermined condition is the vehicle state to be used in the determination of the allocation information.

For example, in the example of FIG. 5A, if the management unit 1 specifies the vehicle state a as the vehicle state in the fourth and subsequent allocation cycle times, the management unit 1 has consecutively specified the identical vehicle state a predetermined number of times or more. In this case, since the current allocation information and the next allocation information are identical, application of the determined allocation information to the virtual devices results in the current allocation information remaining. That is, the management unit 1 uses the No. 2 allocation information again to perform the allocation of the virtual ECUs 5 in the fifth allocation cycle time.

For example, the storage unit 21 may be configured to store the same number of vehicle states as the value of the predetermined number of times. If the predetermined number of times is three, the storage unit 21 can hold three vehicle states. If the storage unit 21 stores three vehicle states, when storing a newly specified vehicle state in the storage unit 21, the management unit 1 overwrites the oldest vehicle state of the three vehicle states stored in the storage unit 21 with the newly specified vehicle state.

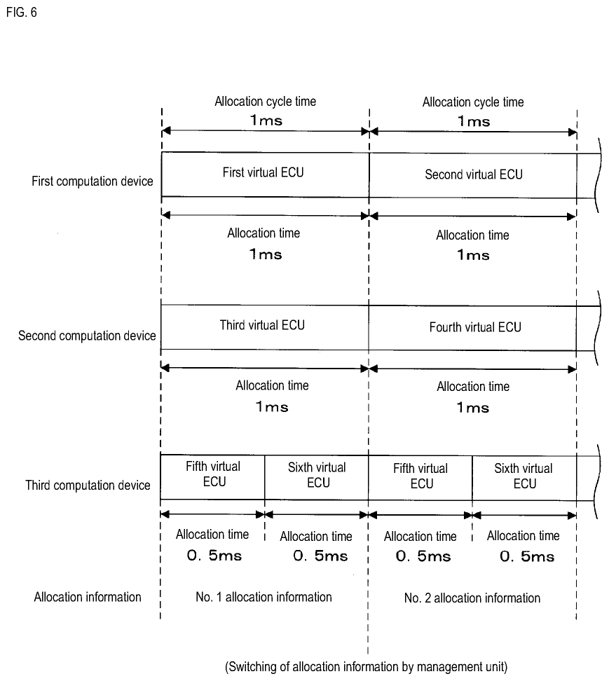

In the example of FIG. 4, a case where the management unit 1 has switched the allocation information from the No. 1 allocation information to the No. 2 allocation information will be described. FIG. 6 is an illustrative diagram showing the virtual ECUs 5 that are allocated to the first computation device 201, the second computation device 202, and the third computation device 203 when the allocation information is switched from the No. 1 allocation information to the No. 2 allocation information.

When using the No. 1 allocation information, during an allocation cycle time of 1 ms, the first computation device 201 is allocated to the first virtual ECU 51 for 1 ms as described above. The second computation device 202 is allocated to the third virtual ECU 53 for 1 ms. The third computation device 203 is allocated to the fifth virtual ECU 55 for 0.5 ms, and is further allocated to the sixth virtual ECU 56 for 0.5 ms. The fourth computation device 204 is allocated to the management unit 1 for 1 ms.

When the allocation information is switched from the No. 1 allocation information to the No. 2 allocation information, during an allocation cycle time of 1 ms, the first computation device 201 is allocated to the second virtual ECU 52 for 1 ms. The second computation device 202 is allocated to the fourth virtual ECU 54 for 1 ms. The third computation device 203 is allocated to the fifth virtual ECU 55 for 0.5 ms, and is further allocated to the sixth virtual ECU 56 for 0.5 ms. The fourth computation device 204 is allocated to the management unit 1 for 1 ms.

When the switching takes place from the No. 1 allocation information to the No. 2 allocation information, the types of virtual ECUs 5 to be allocated to the first computation device 201 and the second computation device 202 are changed. In other words, the management unit 1 applies the allocation information to change the types of virtual ECUs 5 to be allocated to the computation devices 200 (the in-vehicle ECUs 2).

For example, when the vehicle state of the vehicle C has changed from the forward traveling state to the stopped state, the type of the virtual ECU 5 to be allocated to one computation device 200 can be switched from the virtual ECU 5 that operates in the forward traveling state to the virtual ECU 5 that operates in the stopped state. For example, the virtual ECU 5 that operates in the forward traveling state performs processing relating to the sensor 31, which is a radar or the like, and processing relating to the traveling function of the vehicle C. The processing relating to the traveling function of the vehicle C include control processing of the engine, control processing of the accelerator, and others, for example. The virtual ECU 5 that operates in the stopped state performs processing relating to an electric parking brake function and processing relating to a parking monitoring function, for example.

In the example of FIG. 4, when the allocation information is switched from the No. 1 allocation information to the No. 3 allocation information, for example, during an allocation cycle time of 1 ms, the first computation device 201 is allocated to the first virtual ECU 51 for 0.5 ms, and is further allocated to the second virtual ECU 52 for 0.5 ms. The second computation device 202 is allocated to the third virtual ECU 53 for 0.5 ms, and is further allocated to the fourth virtual ECU 54 for 0.5 ms. The third computation device 203 is allocated to the fifth virtual ECU 55 for 0.5 ms, and is further allocated to the sixth virtual ECU 56 for 0.5 ms. The fourth computation device 204 is allocated to the management unit 1 for 1 ms.

When the allocation information is switched from the No. 1 allocation information to the No. 3 allocation information, the number of virtual ECUs 5 to be allocated to the first computation device 201 and the second computation device 202 are changed. In other words, the management unit 1 applies the allocation information to change the number of virtual ECUs 5 to be allocated to the computation devices 200 (the in-vehicle ECUs 2). Since the number of virtual ECUs 5 to be allocated to the allocation destinations is changed, the types of virtual ECUs 5 to be allocated to the allocation destinations are also changed.

When the allocation information is switched from the No. 1 allocation information to the No. 3 allocation information, the allocation times of the first computation device 201 and the second computation device 202 are changed. In other words, the management unit 1 applies the allocation information to change at least one of the times for which the virtual ECUs 5 are to be allocated to the computation devices 200 (the in-vehicle ECU 2).

For example, when the allocation information is switched from the No. 1 allocation information to the No. 4 allocation information, during an allocation cycle time of 1 ms, the first computation device 201 is allocated to the first virtual ECU 51 for 0.5 ms, and is further allocated to the third virtual ECU 53 for 0.5 ms. The second computation device 202 is allocated to the fifth virtual ECU 55 for 1 ms. The third computation device 203 is allocated to the sixth virtual ECU 56 for 1 ms. The fourth computation device 204 is allocated to the management unit 1 for 1 ms. In the first computation device 201, the number and type of virtual ECUs 5, and the allocation time are changed. In the second computation device 202, the type of virtual ECU 5 is changed. In the third computation device 203, the number and type of virtual ECU 5 and the allocation time are changed.

For example, when the allocation information is switched from the No. 1 allocation information to No. N allocation information, during an allocation cycle time of 2 ms, the first computation device 201 is allocated to the first virtual ECU 51 for 1 ms, and is further allocated to the second virtual ECU 52 for 1 ms. The second computation device 202 is allocated to the third virtual ECU 53 for 1 ms, and is further allocated to the fourth virtual ECU 54 for 1 ms. The third computation device 203 is allocated to the fifth virtual ECU 55 for 1 ms, and is further allocated to the sixth virtual ECU 56 for 1 ms. The fourth computation device 204 is allocated to the management unit 1 for 2 ms. N is a natural number.

When the allocation information is switched from the No. 1 allocation information to the No. N allocation information, the allocation cycle time is changed. In other words, the management unit 1 applies the allocation information to change the allocation cycle time. The allocation cycle time is a cycle time during which the virtual ECUs 5 are allocated to the computation devices 200 (the in-vehicle ECU 2). The allocation cycle time corresponds to the cycle time during which the allocation of the virtual devices is performed. When the allocation information is switched from the No. 1 allocation information to the No. N allocation information, the allocation cycle time is changed and also the number of virtual ECUs 5 to be allocated to the first computation device 201 and the second computation device 202 are changed. In addition, the allocation time of the third computation device 203 is changed.

For example, when the allocation information is switched from the No. 1 allocation information to No. N+1 allocation information, during an allocation cycle time of 2 ms, the first computation device 201 is allocated to the first virtual ECU 51 for 1.7 ms, and is further allocated to the second virtual ECU 52 for 0.3 ms. The second computation device 202 is allocated to the third virtual ECU 53 for 1 ms, and is further allocated to the fourth virtual ECU 54 for 1 ms. The third computation device 203 is allocated to the fifth virtual ECU 55 for 1 ms, and is further allocated to the sixth virtual ECU 56 for 1 ms. The fourth computation device 204 is allocated to the management unit 1 for 2 ms. When the switching takes place from the No. 1 allocation information to the No. N+1 allocation information, the allocation cycle time is changed. In the first computation device 201, the number and type of virtual ECUs 5 and the allocation time are changed. In the second computation device 202, the number and type of virtual ECUs 5 are changed. In the third computation device 203, the allocation time is changed.

For example, when the allocation information is switched from the No. 1 allocation information to No. N+2 allocation information, during an allocation cycle time of 2 ms, the first computation device 201 is allocated to the first virtual ECU 51 for 1 ms, and is further allocated to the third virtual ECU 53 for 1 ms. The second computation device 202 is allocated to the fifth virtual ECU 55 for 2 ms. The third computation device 203 is allocated to the sixth virtual ECU 56 for 2 ms. The fourth computation device 204 is allocated to the management unit 1 for 2 ms. When the switching takes place from the No. 1 allocation information to the No. N+2 allocation information, in the first computation device 201, the number and type of virtual ECUs 5 are changed. In the second computation device 202, the type of virtual ECU 5 and the allocation time are changed. In the third computation device 203, the type of virtual ECU 5 and the allocation time are changed.

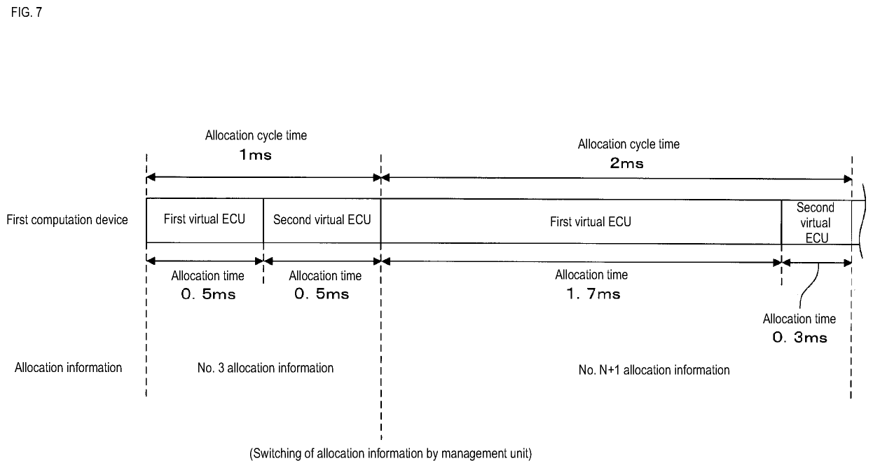

The allocation information may be switched from the allocation information other than the No. 1 allocation information. FIG. 7 is an illustrative diagram showing the virtual ECUs 5 allocated to the first computation device 201 when the allocation information is switched from the No. 3 allocation information to the No. N+1 allocation information. In the case of using the No. 3 allocation information, during an allocation cycle time of 1 ms, the first computation device 201 is allocated to the first virtual ECU 51 for 0.5 ms, and is further allocated to the second virtual ECU 52 for 0.5 ms. When the allocation information is switched from the No. 3 allocation information to the No. N+1 allocation information, the allocation cycle time is changed from 1 ms to 2 ms. During the allocation cycle time of 2 ms, the first computation device 201 is allocated to the first virtual ECU 51 for 1.7 ms, and is further allocated to the second virtual ECU 52 for 0.3 ms.

Description of the allocation of the virtual ECUs 5 to the second computation device 202 and the third computation device 203 when the allocation information is switched from the No. 3 allocation information to the No. N+1 allocation information will be omitted.

For example, when the vehicle state of the vehicle C has changed from the stopped state to the forward traveling state, the time of allocation to the virtual ECU 5 under a large processing load in the forward traveling state can be made longer than the time of allocation to the virtual ECU 5 under a small processing load in the forward traveling state. The virtual ECU 5 under a large processing load in the forward traveling state performs processing related to front side radars provided on the front and side parts of the vehicle C, for example. When the vehicle state of the vehicle C is the forward traveling state, the frequency at which the virtual ECU 5 under a large processing load in the forward traveling state receives signals or messages output from the front and side radars is high. Thus, the time required for the virtual ECU 5 under a large processing load in the forward traveling state to perform the processing is long. In the above-described example, the first virtual ECU 51 corresponds to the virtual ECU 5 under a large processing load in the forward traveling state.

The virtual ECU 5 under a small processing load in the forward traveling state performs processing related to a back radar provided at a back part of the vehicle C, for example. If the vehicle state of the vehicle C is the forward traveling state, the frequency at which the virtual ECU 5 under a small processing load in the forward traveling state receives signals or messages output from the back radar is low. Thus, the time required for the virtual ECU 5 under a small processing load in the forward traveling state to perform the processing is short. In the above-described example, the second virtual ECU 52 corresponds to the virtual ECU 5 under a small processing load in the forward traveling state.

The switching of the allocation information as described above results in changing of at least one of the number of virtual ECUs 5 to be allocated, the type of virtual ECUs 5 to be allocated, the allocation time, and the allocation cycle time. The number of virtual ECUs 5 to be allocated, the type of virtual ECUs 5 to be allocated, the allocation time, and the allocation cycle time are not limited to the above-described examples. For example, the allocation cycle time may be 3 ms or more.

The allocation information is not limited to the above-described examples. Depending on the allocation information, the usage time of any of the first computation device 201, the second computation device 202, and the third computation device 203 does not need to be allocated to the virtual ECUs 5, for example.

For example, the allocation cycle time may vary between the computation devices 200. For example, the allocation cycle times for the first computation device 201 and the second computation device 202 may be 1 ms, and the allocation cycle time for the third computation device 203 may be 2 ms. In this case, the total allocation time of the first computation device 201 is 1 ms. The total allocation time of the second computation device 202 is 1 ms. The total allocation time of the third computation device 203 is 2 ms. When the allocation cycle time of the third computation device 203 elapses once, the allocation cycle times of the first computation device 201 and the second computation device 202 elapse twice.

Among the allocation cycle times of the computation devices 200, when the longest allocation cycle time has elapsed, the management unit 1 specifies the vehicle state and determines whether or not there is a vehicle state satisfying the predetermined condition. In the foregoing example, the management unit 1 specifies the vehicle state when the allocation cycle time of the third computation device 203 elapses. In other words, the management unit 1 specifies the vehicle state when the allocation cycle times of the first computation device 201 and the second computation device 202 have elapsed twice.

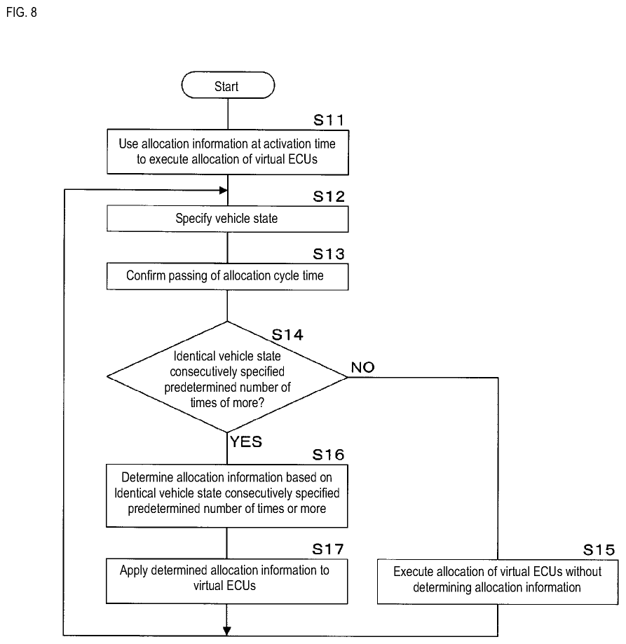

FIG. 8 is a flowchart of processing related to allocation of the virtual ECUs 5 by the management unit 1. For example, when the IG switch of the vehicle C has shifted from the stopped state to the activated state, the fourth computation device 204 functions as the management unit 1. The management unit 1 performs processing described below. In the following description, steps will be abbreviated as S.

The management unit 1 uses the allocation information at the time of activation to execute the allocation of the virtual ECUs 5 (S11). The management unit 1 may specify the vehicle state when the IG switch has shifted from the stopped state to the activated state, and may use the allocation information determined based on the specified vehicle state to execute the allocation of the virtual ECUs 5. As described above, the management unit 1 specifies the vehicle state once the allocation cycle time has elapsed from the point in time at which the management unit 1 started the allocation of the virtual ECUs 5 (S12), and stores the specified vehicle state in the storage unit 21. In the specification of the vehicle state, the management unit 1 may acquire the vehicle state from the virtual ECUs 5 and specify the vehicle state based on the state of the hardware or the specification information acquired from the virtual ECUs 5.

The management unit 1 confirms that the allocation cycle time has elapsed from the point in time at which the management unit 1 started the allocation of the virtual ECUs 5 (S13). The management unit 1 determines whether an identical vehicle state has been consecutively specified a predetermined number of times or more (S14). That is, the management unit 1 determines whether or not an identical vehicle state has continued a predetermined number of times or more. If the management unit 1 has not consecutively specified an identical vehicle state a predetermined number of times or more (S14: NO), that is, if an identical vehicle state has not continued a predetermined number of times or more, the management unit 1 executes the allocation of the virtual ECUs 5 without determining the allocation information as described above (S15). More specifically, the management unit 1 uses the allocation information identical to the allocation information used in the immediately previous allocation cycle time to perform the allocation of the virtual ECUs 5. The management unit 1 performs step S12 again once the allocation cycle time has elapsed from the point in time at which the management unit 1 started the allocation of the virtual ECUs 5.

If the management unit 1 has consecutively specified an identical vehicle state a predetermined number of times or more (S14: YES), that is, if the identical vehicle state has continued a predetermined number of times or more, the management unit 1 determines the allocation information based on the identical vehicle state that has been consecutively specified a predetermined number of times or more (S16). As described above, the management unit 1 applies the determined allocation information to the virtual ECUs 5 (S17). In other words, the management unit 1 uses the determined allocation information to execute the allocation of the virtual ECUs 5. The management unit 1 performs step S12 again once the allocation cycle time has elapsed from the point in time at which the management unit 1 started the allocation of the virtual ECUs 5.

The management unit 1 ends the process when the IG switch has shifted from the activated state to the stopped state, for example.

In the present embodiment, the plurality of virtual ECUs 5 are generated in response to the control unit 20 of the in-vehicle ECU 2 activating the virtualization operating system. The control unit 20 also functions as the management unit 1 that manages the plurality of virtual ECUs 5. The storage unit 21 stores the plurality of pieces of allocation information for the management unit 1 to allocate the virtual ECUs 5 to the in-vehicle ECU 2. The management unit 1 specifies the vehicle state, and determines a piece of allocation information based on the specified vehicle state. The management unit 1 applies the determined allocation information to the virtual ECUs 5. In other words, the management unit 1 uses the determined allocation information to allocate the virtual ECUs 5 to the in-vehicle ECU 2. When the management unit 1 applies the determined allocation information to the virtual devices, if the current allocation information and the next allocation information are identical, the determined allocation information to be applied to the virtual devices remains as the current allocation information. If the current allocation information and the next allocation information are different, the management unit 1 applies the next allocation information to switch the allocation information for use in the allocation of the virtual ECUs 5 from the current allocation information to the next allocation information. The management unit 1 can appropriately switch the allocation of the virtual ECUs 5 to the in-vehicle ECU 2 in accordance with the vehicle state. In other words, the management unit 1 can appropriately allocate the virtual ECUs 5 to the in-vehicle ECU 2 in accordance with the vehicle state. Since the management unit 1 switches the allocation information in accordance with the vehicle state, it is possible to achieve flexible allocation of the virtual ECUs 5. In other words, the virtual ECUs 5 can be flexibly arranged.

In the specification of the vehicle state, the management unit 1 acquires the vehicle state from the virtual ECUs 5 or specifies the vehicle state based on the specification information or the state of the hardware. In the case where the management unit 1 acquires the vehicle state from the virtual ECUs 5, the virtual ECUs 5 specify the vehicle state and output the specified vehicle state to the management unit 1. The management unit 1 acquires the vehicle state output from the virtual ECUs 5. Since the management unit 1 acquires the vehicle state specified by the virtual ECUs 5 from the virtual ECUs 5, it is possible to reduce the processing performed by the management unit 1 to specify the vehicle state.

In the case where the management unit 1 specifies the vehicle state based on the specification information, the virtual ECUs 5 output the specification information to the management unit 1, for example. The management unit 1 acquires the specification information output from the virtual ECUs 5, and specifies the vehicle state based on the acquired specification information. Since the virtual ECUs 5 do not need to specify the vehicle state, it is possible to reduce the processing to be performed by the virtual ECUs 5. In the case where the management unit 1 specifies the vehicle state based on the state of hardware of the in-vehicle ECU 2, the management unit 1 can specify the vehicle state without involving the virtual ECUs 5. Since the virtual ECUs 5 do not need to perform processing in the specification of the vehicle state, it is possible to reduce the processing performed by the virtual ECUs 5.

The management unit 1 specifies the vehicle state a plurality of times. The management unit 1 determines whether or not, among the plurality of specified vehicle states, an identical vehicle state has continued a predetermined number of times or more. If an identical vehicle state has continued a predetermined number of times or more, the management unit 1 determines the allocation information based on the identical vehicle state, and applies the determined allocation information to the virtual ECUs 5. In other words, the management unit uses the allocation information determined based on the identical vehicle state having continued a predetermined number of times or more to perform the allocation of the virtual ECUs 5. If no identical vehicle state has continued a predetermined number of times or more, the management unit 1 does not determine the allocation information. The management unit 1 uses the allocation information already applied to the virtual ECUs 5 to allocate the virtual ECUs 5. If the frequency of change in the vehicle state is high, for example, even in the event of hunting, the management unit 1 can appropriately allocate the virtual ECUs 5 to the computation devices 200 (the in-vehicle ECUs 2). The management unit 1 can reduce the influence of hunting on the specification of the vehicle state.

The types of virtual ECUs 5 to be allocated to the computation devices 200 are changed as a result of the management unit 1 applying the allocation information. The management unit 1 can allocate the appropriate types of virtual ECUs 5 to the computation devices 200 in accordance with the vehicle state.

The number of virtual ECUs 5 to be allocated to the computation devices 200 is changed as a result of the management unit 1 applying the allocation information. The management unit 1 can allocate an appropriate number of virtual ECUs 5 to the computation devices 200 in accordance with the vehicle state.

The allocation times of the computation devices 200 are changed as a result of the management unit applying the allocation information 1. More specifically, at least one of the times for which the virtual ECUs 5 are to be allocated to the computation devices 200 is changed. The management unit can allocate the virtual ECUs 5 to the computation devices 200 for appropriate times that correspond to the vehicle state.

The allocation cycle time is changed as a result of the management unit 1 applying the allocation information. More specifically, the cycle time in which the virtual ECUs 5 are to be allocated to the computation devices 200 is changed. The management unit 1 can allocate the virtual ECUs 5 to the in-vehicle ECU 2 in the appropriate allocation cycle time that corresponds to the vehicle state.

In the present embodiment, the management unit 1 specifies the vehicle state, determines whether or not the specified vehicle state satisfies a predetermined condition, and determines the allocation information based on the vehicle state satisfying a predetermined condition. However, the management unit 1 does not need to determine whether the vehicle state satisfies a predetermined condition. For example, the management unit 1 may specify the vehicle state once when the allocation cycle time has elapsed, and determine the allocation information based on the vehicle state specified once. The management unit 1 applies the allocation information determined based on the vehicle state specified once to the virtual ECUs 5.

In the present embodiment, the fourth computation device 204 functions as the management unit 1. However, any computation device 200 other than the fourth computation device 204 may function as the management unit 1. For example, each computation device 200 may function as a virtual ECU 5 and function as the management unit 1.

For example, an example in which the first computation device 201 functions as a virtual ECU 5 and functions as the management unit 1 will be described. The first computation device 201 cyclically switches between a period during which the first computation device 201 functions as the virtual ECU 5 allocated thereto and a period during which the first computation device 201 functions as a first management unit that manages the virtual ECU 5 allocated thereto. A first allocation information table that stores pieces of allocation information regarding the virtual ECU 5 allocated to the first computation device 201 is stored in the storage unit 21, for example, in a virtual storage unit of the first computation device 201. The first management unit allocates the virtual ECU 5 to the first computation device 201 based on a piece of the allocation information stored in the first allocation information table. Similarly to the management unit 1, the first management unit specifies the vehicle state and determines the allocation information to be used in the allocation of the virtual ECU 5 to the first computation device 201 based on the specified vehicle state. The first management unit uses the determined allocation information to allocate the virtual ECU 5 to the first computation device 201. The computation devices 200 other than the first computation device 201 function as the virtual ECU 5 and function as the management unit 1, similarly to the first computation device 201.

### Second Embodiment

Among components according to a second embodiment, components that are the same as those in the first embodiment will be given identical reference signs and detailed description thereof will be omitted. The second embodiment relates to an in-vehicle ECU 2 that, when the management unit 1 specifies the vehicle state a plurality of times and, if the number of times an identical state has continued among the plurality of specified vehicle states is greater than or equal to a predetermined value, determines allocation information based on the identical vehicle state.

The in-vehicle ECU 2 in the second embodiment includes a control unit 20 and a storage unit 21. As in the first embodiment, the control unit 20 includes four computation devices 200, that is, a first computation device 201, a second computation device 202, a third computation device 203, and a fourth computation device 204. The storage unit 21 stores an allocation information table 210. The storage unit 21 also stores a count value indicating the number of times a management unit 1 has specified the vehicle state.

As in the first embodiment, six virtual ECUs 5, that is, a first virtual ECU 51, a second virtual ECU 52, a third virtual ECU 53, a fourth virtual ECU 54, a fifth virtual ECU 55, and a sixth virtual ECU 56 are constructed in the in-vehicle ECU 2. The virtual ECUs 5 are allocated to the first computation device 201, the second computation device 202, and the third computation device 203. The fourth computation device 204 functions as the management unit 1 that manages the six virtual ECUs 5.

The management unit 1 uses a piece of allocation information stored in the allocation information table 210 to allocate the virtual ECUs 5 to the first computation device 201, the second computation device 202, and the third computation device 203. As in the first embodiment, the management unit 1 specifies the vehicle state upon a lapse of an allocation cycle time. Upon specification of the vehicle state, the management unit 1 increases the count value stored in the storage unit 21 by 1. The management unit 1 stores the specified vehicle state in the storage unit 21. For example, the management unit 1 may store the specified vehicle state and the increased count value in the storage unit 21 in association with each other.

Once the allocation cycle time has elapsed, the management unit 1 determines the allocation information to be used in the allocation of the virtual ECUs 5 based on the vehicle state satisfying a predetermined condition. If there is no vehicle state satisfying a predetermined condition, the management unit 1 does not determine the allocation information.

The predetermined condition in the second embodiment is that the number of times an identical vehicle state has continued in a plurality of specified vehicle states is greater than or equal to a predetermined value. In other words, the predetermined condition in the second embodiment is that, in the specification of the vehicle state a plurality of times, the number of times an identical vehicle state has been specified is greater than or equal to a predetermined value. In the present embodiment, the specification of the vehicle state is performed a predetermined certain number of times. The predetermined value is 50% of the certain number of times. In this case, the predetermined condition is that, in the specification of the vehicle state a certain number of times, the number of times an identical vehicle state has been specified is 50% or more of the certain number of times. For example, the predetermined value and the certain number of times are stored in advance in the storage unit 21. The predetermined value is not limited to the foregoing example. For example, the predetermined value may be 70% of the certain number of times or 90% of the certain number of times.

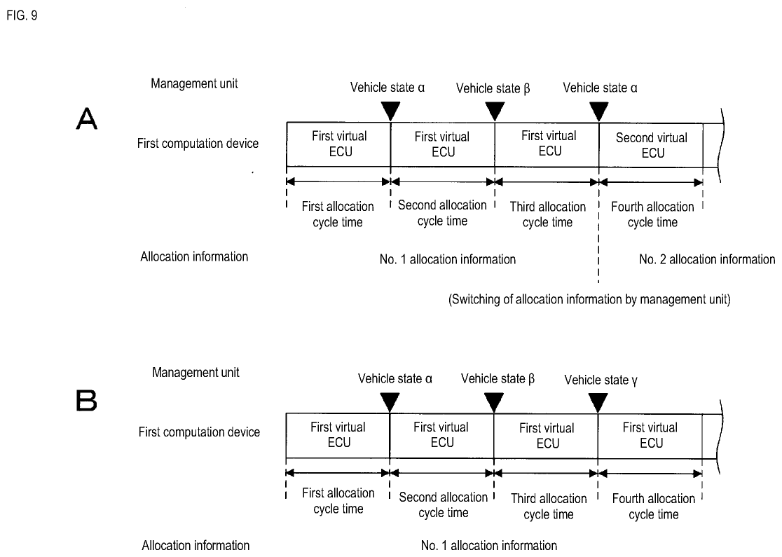

FIG. 9 is an illustrative example showing an example of specification of the vehicle state and switching of the allocation information in the second embodiment. FIG. 9 shows the management unit 1 and the first computation device 201 for the sake of description. The points in time at which the management unit 1 specifies the vehicle state are denoted by solid black triangles. In the example of FIG. 9, the certain number of times is three.

FIG. 9A is an illustrative diagram showing a case where the vehicle state satisfies a predetermined condition, that is, a case where the allocation information is determined. In the example of FIG. 9A, the allocation information to be used in the first allocation cycle time is No. 1 allocation information. When starting the allocation of the virtual ECUs 5 in the first allocation cycle time, the management unit 1 sets the count value to 0. The vehicle state specified by the management unit 1 when the first allocation cycle time has elapsed is a vehicle state a. Upon specification of the vehicle state, the management unit 1 increases the count value by 1.

Since the specification of the vehicle state has not been performed a certain number of times, the management unit 1 does not determine the allocation information. The management unit 1 uses the No. 1 allocation information again to allocate the virtual ECUs 5 in the second allocation cycle time. The vehicle state specified by the management unit 1 once the second allocation period has elapsed is a vehicle state β. The management unit 1 increments the count value by 1. Since the specification of the vehicle state has not been performed a certain number of times, the management unit 1 does not determine the allocation information. The management unit 1 uses the No. 1 allocation information again to allocate the virtual ECUs 5 in the third allocation cycle time.

The vehicle state specified by the management unit 1 once the third allocation cycle time has elapsed is the vehicle state a. The management unit 1 increases the count value by 1. The specification of the vehicle state has been performed three times. That is, the specification of the vehicle state has been performed the certain number of times. Thus, the management unit 1 determines whether or not, among the vehicle states specified a certain number of times, there is a vehicle state that has been specified a number of times that is 50% or more of the certain number of times. In other words, the management unit 1 determines whether the number of times an identical vehicle state has continued among the plurality of specified vehicle states is greater than or equal to the predetermined value. In the foregoing example, of the three times the vehicle state was specified, the management unit 1 specified the vehicle state a twice and specified the vehicle state β once. In this case, of the vehicle states specified a certain number of times, the vehicle state a is a vehicle state that has been specified a number of times that is 50% or more of the certain number of times. That is, the vehicle state a is a vehicle state that satisfies the predetermined condition. The management unit 1 determines the allocation information based on the vehicle state a and applies the determined allocation information to the virtual ECUs 5 as in the first embodiment. In the example of FIG. 9A, the allocation information is switched from the No. 1 allocation information to the No. 2 allocation information. Hereinafter, the determination by the management unit 1 as to whether or not, among the vehicle states specified a certain number of times, there is a vehicle state that has been specified a number of times that is 50% or more of the certain number of times will also be called “condition determination”.

FIG. 9B is an illustrative diagram showing a case where the vehicle state does not satisfy a predetermined condition, that is, a case where no allocation information is determined. In the example of FIG. 9B, the vehicle state specified by the management unit 1 once the first allocation cycle time has elapsed is the vehicle state α. The vehicle state specified by the management unit 1 once the second allocation cycle time has elapsed is the vehicle state β. The vehicle state specified by the management unit 1 once the third allocation cycle time has elapsed is a vehicle state γ. The management unit 1 performs condition determination. In the example of FIG. 9B, among the vehicle states specified by the management unit 1 a certain number of times, there is no vehicle state that has been specified a number of times that is 50% or more of the certain number of times. Since there is no vehicle state that satisfies the predetermined condition, the management unit 1 does not determine the allocation information. The management unit 1 uses the allocation information identical to the allocation information used in the previous allocation cycle time to allocate the virtual ECUs 5.

For example, after the condition determination, the management unit 1 sets the count value to 0. As described above, the management unit 1 specifies the vehicle state and increases the count value. When the count value reaches a value identical to the certain number of times, the management unit 1 performs condition determination. In other words, whenever the management unit 1 specifies the vehicle state a certain number of times, the management unit 1 determines whether or not, among the vehicle states specified a certain number of times, there is a vehicle state that has been specified a number of times that is 50% or more of the certain number of times.

The management unit 1 may perform condition determination each time the allocation cycle time elapses. For example, when the fourth allocation cycle time has elapsed, the management unit 1 performs condition determination using three vehicle states, that is, the vehicle state specified in the fourth allocation cycle time, the vehicle state specified in the third allocation cycle time, and the vehicle state specified in the second allocation cycle time.

Hereinafter, description will be given as to an example in which the management unit 1 performs condition determination each time the allocation cycle time elapses, where the certain number of times is N times and the predetermined value is 50% of the certain number of times. N is a natural number. The storage unit 21 stores N−1 vehicle states or more. The management unit 1 specifies the vehicle state once the allocation cycle time has elapsed, and stores the specified vehicle state in the storage unit 21. The management unit 1 performs condition determination using, among a plurality of vehicle states stored in the storage unit 21, N vehicle states including the most recently stored vehicle state to the N−1 vehicle states stored prior to the most recently stored vehicle state. In other words, the management unit 1 performs condition determination using, among the plurality of specified vehicle states, N vehicle states including the most recently specified vehicle state to the N−1 vehicle states specified prior to the most recently specified vehicle state.

If there is a vehicle state that has been specified a number of times that is 50% or more of N, the management unit 1 determines allocation information based on the vehicle state that has been specified a number of times that is 50% or more of N. If there is no vehicle state that has been specified a number of times that is 50% or more of N, the management unit 1 does not determine the allocation information.

In the present embodiment, upon specification of the vehicle state, the management unit 1 increases the count value by 1, and stores the specified vehicle state and the increased count value in the storage unit 21 in association with each other. The management unit 1 may store the specified vehicle state and the time when the vehicle state was specified in the storage unit 21 in association with each other.

For example, the storage unit 21 may be configured to store the same number of vehicle states as the value of the certain number of times. If the certain number of times is three, the storage unit 21 can store three vehicle states. If the management unit 1 performs condition determination whenever the management unit 1 has specified the vehicle state a certain number of times, for example, three times, the management unit 1 stores the specified vehicle state in the storage unit 21 each time the vehicle state is specified. When the number of vehicle states stored in the storage unit 21 has reached three, the management unit 1 performs condition determination. After the condition determination, the management unit 1 erases the three vehicle states from the storage unit 21. When the number of vehicle states stored in the storage unit 21 reaches three again, the management unit 1 performs condition determination.

For example, if the management unit 1 performs condition determination each time the allocation cycle time elapses, the management unit 1 stores the specified vehicle state in the storage unit 21 at each instance of specification of the vehicle state. In storing a newly specified vehicle state in the storage unit 21, if the three vehicle states are already stored in the storage unit 21, the management unit 1 updates the three vehicle states stored in the storage unit 21 by overwriting the oldest vehicle state among the three vehicle states stored in the storage unit 21 with the newly specified vehicle state. Each time the allocation cycle time elapses, the management unit 1 performs condition determination using the updated three vehicle states stored in the storage unit 21.

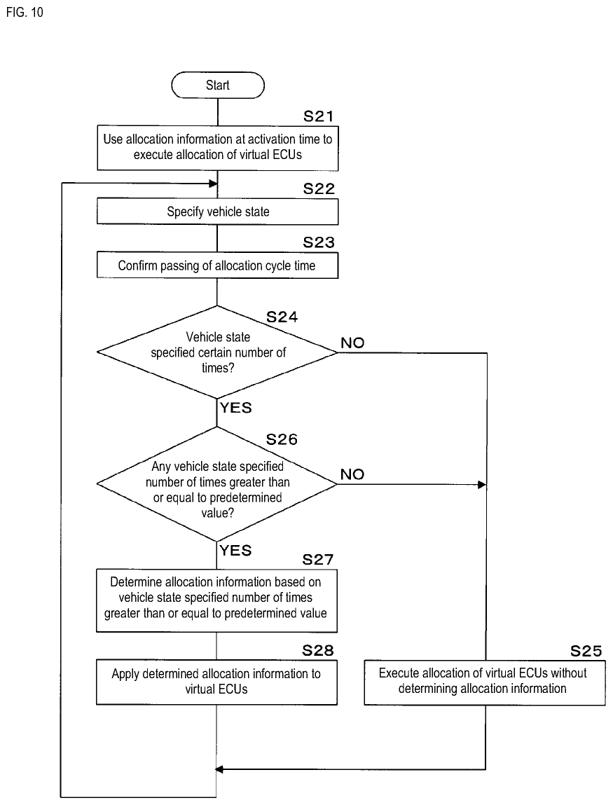

FIG. 10 is a flowchart of processing relating to allocation of virtual ECUs 5 by the management unit 1 in the second embodiment. For example, when the IG switch of the vehicle C shifts from the stopped state to the activated state, the fourth computation device 204 functions as the management unit 1. The management unit 1 performs the processing described below.

The management unit 1 performs steps S21, S22, and S23. Since steps S21, S22, and S22 are similar to steps S11, S12, and S13 in the first embodiment, detailed description thereof will be omitted. The management unit 1 determines whether or not the vehicle state has been specified a certain number of times (S24). For example, the management unit 1 determines whether or not the number of vehicle states stored in the storage unit 21 is greater than or equal to the value of the certain number of times.

If the management unit 1 has not specified the vehicle state the certain number of times (S24: NO), the management unit 1 allocates the virtual ECUs 5 without determining the allocation information (S25). More specifically, the management unit 1 uses the allocation information identical to the allocation information used in the previous allocation cycle time to allocate the virtual ECUs 5. When the allocation cycle time has elapsed again from the point in time at which the management unit 1 started allocation of the virtual ECUs 5, the management unit 1 performs step S22. The case where the management unit 1 has not determined the vehicle state the certain number of times includes a case where the number of vehicle states stored in the storage unit 21 is smaller than the number identical to the value of the certain number of times, for example.

When the management unit 1 has specified the vehicle state the certain number of times (S24: YES), the management unit 1 determines whether or not, among the vehicle states specified the certain number of times, there is a vehicle state that has been specified a number of times that is greater than or equal to a predetermined value (S26). The case where the management unit 1 has specified the vehicle state the certain number of times includes a case where the number of vehicle states stored in the storage unit 21 is greater than or equal to the number identical to the value of the certain number of times, for example. If there is no vehicle state that has been specified a number of times greater than or equal to a predetermined value (S26: NO), the management unit 1 performs step S25.

If there is a vehicle state that has been specified a number of times greater than or equal to a predetermined value (S26: YES), the management unit 1 determines the allocation information based on the vehicle state that has been specified a number of times greater than or equal to a predetermined value (S27). As described above, the management unit 1 applies the determined allocation information to the virtual ECUs 5 (S28). In other words, the management unit 1 uses the determined allocation information to allocate the virtual ECUs 5. When the allocation cycle time has elapsed again from the point in time at which the management unit 1 started the allocation of the virtual ECUs 5, the management unit 1 performs step S22.

The management unit 1 ends the processing when the IG switch shifts from the activated state to the stopped state, for example.

In the present embodiment, the management unit 1 specifies the vehicle state a plurality of times. The management unit 1 determines whether or not, among the plurality of specified vehicle states, the number of times an identical vehicle state has been specified is greater than or equal to a predetermined value. If the number of times an identical vehicle state has been specified is greater than or equal to a predetermined value, the management unit 1 determines the allocation information based on the identical vehicle state that has been specified a number of times greater than or equal to a predetermined value, and applies the determined allocation information to the virtual ECUs 5. In other words, the management unit 1 uses the allocation information determined based on, among the plurality of specified vehicle states, the identical vehicle state that has been specified a number of times greater than or equal to a predetermined value to perform the allocation of the virtual ECUs 5. If the number of times the identical vehicle state has been specified is smaller than a predetermined value, the management unit 1 does not determine the allocation information. The management unit 1 uses the allocation information already applied to the virtual ECUs 5 to perform the allocation of the virtual ECUs 5. If the frequency of change in the vehicle state is high, for example, even in the event of hunting, the management unit 1 can appropriately allocate the virtual ECUs 5 to the in-vehicle ECU 2. The management unit 1 can reduce the influence of the hunting on the specification of the vehicle state.

The embodiments disclosed herein should be regarded as being illustrative and not limitative in all respects. The scope of the present disclosure is indicated by the scope of claims, not by the above description, and is intended to include all modifications within the meaning and scope equivalent to the scope of claims.

1. An in-vehicle apparatus that is mounted in a vehicle and generates a plurality of virtual devices that are operating environments for a plurality of programs, the in-vehicle apparatus comprising:
a management unit that manages the plurality of virtual devices,
wherein the management unit specifies a vehicle state that indicates a state of the vehicle and, based on the specified vehicle state, determines a piece of allocation information for allocating the virtual devices to the own apparatus, and applies the determined allocation information to the virtual devices.

2. The in-vehicle apparatus according to claim 1, wherein the management unit acquires specification information for specifying the vehicle state from the virtual devices, and specifies the vehicle state based on the acquired specification information.

3. The in-vehicle apparatus according to claim 1, wherein the virtual devices specify the vehicle state, and
the management unit acquires the vehicle state specified by the virtual devices from the virtual devices.

4. The in-vehicle apparatus according to claim 1, wherein the management unit specifies the vehicle state based on a state of hardware of the own apparatus.

5. The in-vehicle apparatus according to claim 1, wherein the management unit specifies the vehicle state a plurality of times, and
if, among the plurality of specified vehicle states, an identical vehicle state has continued a predetermined number of times or more, the management unit determines the allocation information based on the identical vehicle state.

6. The in-vehicle apparatus according to claim 1, wherein the management unit specifies the vehicle state a plurality of times, and
if, among the plurality of specified vehicle states, the number of times an identical vehicle state has been specified is greater than or equal to a predetermined value, the management unit determines the allocation information based on the identical vehicle state.

7. The in-vehicle apparatus according to claim 1, wherein the management unit applies the allocation information to change a type of the virtual devices to be allocated.

8. The in-vehicle apparatus according to claim 1, wherein the management unit applies the allocation information to change the number of virtual devices to be allocated.

9. The in-vehicle apparatus according to claim 1, wherein the management unit applies the allocation information to change at least one of the times at which the virtual devices are to be allocated.

10. The in-vehicle apparatus according to claim 1, wherein the management unit applies the allocation information to change a cycle time in which the virtual devices are to be allocated.

11. An information processing method performed by an in-vehicle apparatus that is mounted in a vehicle and generates a plurality of virtual devices that are operating environments of a plurality of programs, the information processing method comprising:
specifying a vehicle state that indicates a state of the vehicle;
based on the specified vehicle state, determining a piece of allocation information for allocating the virtual devices to the in-vehicle apparatus; and
applying the determined allocation information to the virtual devices.

12. A computer program for causing a computer that is mounted in a vehicle and generates a plurality of virtual devices that are operating environments of a plurality of programs, to execute a process, the process comprising:
specifying a vehicle state that indicates a state of the vehicle;
based on the specified vehicle state, determining a piece of allocation information for allocating the virtual devices to the computer; and
applying the determined allocation information to the virtual devices.
